(19) United States
(12) Patent Application Publication
(10) Pub. No.: US 2021/0400651 A1
(43) Pub. Date: Dec. 23, 2021

(54) APPARATUSES, DEVICES AND METHODS FOR PERFORMING BEAM MANAGEMENT

(71) Applicant: Telefonaktiebolaget LM Ericsson (publ), Stockholm (SE)

(72) Inventors: Johan OTTERSTEN, Stockholm (SE); Hugo TULLBERG, Nyköping (SE)

(21) Appl. No.: 17/288,686

(22) PCT Filed: Aug. 15, 2018
(86) PCT No.: PCT/SE2018/050827

§ 371 Date: Apr. 26, 2021

(51) Int. Cl. H04W 72/04; H04W 64/00; H04L 1/18; G06N 20/00

(52) U.S. Cl. CPC H04W 72/046; G06N 20/00; H04L 1/18; H04W 64/00

(57) ABSTRACT

The present disclosure relates to radio network communication. In one of its aspects, the disclosure presented herein concerns a method for performing beam management. The method is implemented by an apparatus. According to the method, an initial coarse Beam Pair Link (BPL) is established with a device. Information from at least one sensor at the device is acquired. The acquired information is input into a machine learning model, wherein the machine learning model is trained to predict beam indices from sensor information and refined beam indices are received, from the machine learning model, wherein the machine learning model has predicted the refined beam indices from the input information. Thereafter, a refined BPL is established with the device, based on the predicted refined beam indices.

### TECHNICAL FIELD

The present disclosure generally relates to telecommunications. In particular, the various embodiments described in this disclosure relate to apparatuses, devices and methods for performing beam management.

### BACKGROUND

This section is intended to provide a background to the various embodiments of the invention that are described in this disclosure. Therefore, unless otherwise indicated herein, what is described in this section should not be interpreted to be prior art by its mere inclusion in this section.

In order to meet traffic demands in wireless communication systems such as New Radio (NR), 5G, new frequency bands are being considered, for example in the range of 30-100 GHz. These bands generally offer wide spectrum for high data rate communications, but due to system and channel characteristics, the coverage range is limited. Propagation loss is typically higher for long range communications at high frequencies. A promising way to overcome the range limitations may be based on multi-antenna strategies. At high frequencies, antenna elements generally get smaller, making it possible to use a large number of antenna elements without making the antenna size prohibitively large. By using a large number of antenna elements, it may be possible to form narrow beams and steer a signal toward a specific direction and overcoming the high propagation loss for long range communication. This is usually referred to as beamforming.

An important function in wireless communication systems using a large number of antenna elements is beam management. Using 3GPP terminology, this usually comprises three stages; P1, P2 and P3. P1 typically comprises the initial access where a transmitter sends Synchronization Signal (SS) blocks in form of different wide beams to establish initial beams for the transmitter and a receiver. The receiver measures and identifies a good SS block beam and adjusts its receiver beam and transmit Random-Access CHannel (RACH) to the corresponding transmitter beam. During P1, the transmitter and the receiver perform a sweep, where they search through all available wide beams to find the best coarse Beam Pair Link (BPL). When P1 is completed, the transmitter and the receiver generally can exchange messages using the established coarse beams. P2 typically comprises refining the initial beam at the transmitter, i.e. the base station, and P3 typically comprises refining the initial beam at the receiver, i.e. the User Equipment (UE). This establishes a link of two narrow beams, which may increase the gain and provide better communication.

P2 and P3 can either be done separately or jointly. Beam indication is the procedure to exchange information between transmitter and receiver to allow them to switch beams simultaneously. This is only required in the joint P2/P3 sweep, otherwise the transmitter and the receiver may adjust their beams without indication. A separate P2/P3 sweep may involve refining the beam at the transmitter first, while keeping the receiver beam fixed, and then refining the receiver beam, keeping the transmitter beam fixed. In the separate sweep, all of the beam combinations are not observed and therefore it requires less overhead compared to the joint P2/P3 sweep, which performs an exhaustive search through all of the beams to find the best pair.

A more detailed description about beam management without beam indication may be found in R1-1718742, “Performance of beam management without beam indication”, Ericsson, RANI #90bis, Prague, October 2017.

### SUMMARY

It is in view of the above background and other considerations that the various embodiments of the present disclosure have been made.

In future 5G scenarios there may be a large number of antenna elements and hence, a large number of beams. In these scenarios, the above described beam refinement processes (P2 and P3), which takes place after the establishment of the initial transmitter and receiver beams (P1), may be costly in terms of signaling overhead and delay. This is because channel state information reference signals (CSI-RS) generally need to be reported for the selected number of narrow beams during the refinement process. The selected number of narrow beams spans the area of the SS block beam used in P1. This number may vary, but is typically high and therefore a large number of CSI-RS need to be reported. A separate P2/P3 sweep requires less CSI-RS reporting while a joint P2/P3 sweep requires more as all of the beams are swept. In scenarios where there may be many reflections and beams need to be switched simultaneously, it may not be possible to rely on the separate P2/P3 sweep without beam indication, which would require less overhead. Instead, the joint P2/P3 with beam indication may have to be used. This typically increases complexity, overhead and delay because of the required CSI-RS reporting.

In view of the above, it is therefore a general object of the aspects and embodiments described throughout this disclosure to provide a solution which mitigates, alleviates or reduces, the need to perform an exhaustive search through all of beams and accordingly mitigates the need to perform P2 and P3 in an initial access situation.

This general object has been addressed by the appended independent claims. Advantageous embodiments are defined in the appended dependent claims.

According to a first aspect, there is provided a method, implemented by an apparatus, for performing beam management.

An initial coarse Beam Pair Link (BPL) is established with a device. Information from at least one sensor at the device is acquired. The acquired information is input into a machine learning model, wherein the machine learning model is trained to predict beam indices from sensor information. Refined beam indices are received from the machine learning model, wherein the machine learning model has predicted the refined beam indices from the input information; and a refined BPL is established with the device, based on the predicted refined beam indices.

In one embodiment, the acquired sensor information is processed; and the processed sensor information is input into the machine learning model.

In one embodiment, the acquired sensor information includes location information indicative of a location of the device.

In one embodiment accuracy of the predicted beam indices is tracked; and the machine learning model is updated in accordance with the tracked accuracy. In one example, tracking accuracy of the predicted beam indices comprises comparing the predicted beam indices to a set of strongest Channel State Information Reference Symbol (CSI-RS) measurements received from the device. In another example, tracking accuracy of the predicted beam indices comprises confirming whether messages between the apparatus and the device were received correctly using ACK/NACK information.

In one embodiment, when the machine learning model is in a training mode, the method further comprises obtaining a refined BPL by refining the initial coarse BPL by beam sweeping, wherein the obtained refined BPL is used as target data for the machine learning model; and feeding the machine learning model with the obtained target data.

In one embodiment, the machine learning model is located separately and remotely from the apparatus. The machine learning model may for example be located within a computer server system comprising one or more computer servers.

In one embodiment, the machine learning model is internal to the apparatus.

According to a second aspect, there is provided an apparatus for implementing the method according to the first aspect.

In one exemplary implementation, the apparatus comprises a processing circuitry; and a memory circuitry storing computer program code which, when run in the processing circuitry, causes the apparatus to perform beam management. The computer program code, when run in the processing circuitry, causes the apparatus to establish an initial coarse Beam Pair Link (BPL) with a device and acquire information from at least one sensor at the device. The computer program code, when run in the processing circuitry, causes the apparatus to input the acquired information into a machine learning model, wherein the machine learning model is trained to predict beam indices from sensor information; and to receive, from the machine learning model, refined beam indices, wherein the machine learning model has predicted the refined beam indices from the input information. The computer program code, when run in the processing circuitry, then causes the apparatus to establish a refined BPL with the device, based on the predicted refined beam indices.

In one embodiment, the memory circuitry storing computer program code which, when run in the processing circuitry, causes the apparatus to train the machine learning model by process the acquired sensor information; and input the processed sensor information into the machine learning model.

In one embodiment, the acquired sensor information includes location information indicative of a location of the device.

In one embodiment, the memory circuitry storing computer program code which, when run in the processing circuitry, causes the apparatus to track accuracy of the predicted beam indices; and update the machine learning model in accordance with the tracked accuracy. In one example, the memory circuitry storing computer program code which, when run in the processing circuitry, causes the apparatus to track accuracy of the predicted beam indices by comparing the predicted beam indices to a set of strongest Channel State Information Reference Symbol (CSI-RS) measurements received from the device. In another example, the memory circuitry storing computer program code which, when run in the processing circuitry, causes the apparatus to track accuracy of the predicted beam indices by confirming whether messages between the apparatus and the device were received correctly using ACK/NACK information.

In one embodiment, the machine learning model is located separately and remotely from the apparatus. The machine learning model may for example be located within a computer server system comprising one or more computer servers.

In one embodiment, the machine learning model is internal to the apparatus.

In one embodiment, the apparatus is a transmission point. The apparatus may for example be a base station.

In one embodiment, the memory circuitry storing computer program code which, when run in the processing circuitry and when the machine learning model is in a training mode, causes the apparatus to obtain a refined BPL by refining the initial coarse BPL by beam sweeping, wherein the obtained refined BPL is used as target data for the machine learning model; and feeding the machine learning model with the obtained target data.

According to a third aspect, there is provided an apparatus. The apparatus comprises means adapted to establish an initial coarse Beam Pair Link, BPL, with a device. The apparatus further comprises means adapted to acquire information from at least one sensor at the device, and means adapted to input the acquired information into a machine learning model, wherein the machine learning model is trained to predict beam indices from sensor information. The apparatus further comprises means adapted to receive, from the machine learning model, refined beam indices, wherein the machine learning model has predicted the refined beam indices from the input information; and means adapted to establish a refined BPL with the device, based on the predicted refined beam indices.

According to a fourth aspect, there is provided an apparatus. The apparatus comprises a first module configured to establish an initial coarse Beam Pair Link, BPL, with a device, and a second module configured to acquire information from at least one sensor at the device. The apparatus further comprises a third module configured to input the acquired information into a machine learning model, wherein the machine learning model is trained to predict beam indices from sensor information, a fourth module configure to receive, from the machine learning model, refined beam indices, wherein the machine learning model has predicted the refined beam indices from the input information, and a fifth module configured to establish a refined BPL with the device, based on the predicted refined beam indices.

According to a fifth aspect, there is provided a method, implemented by a device, for performing beam management.

An initial coarse Beam Pair Link (BPL) is established with an apparatus. Information from at least one sensor is transmitted to the apparatus; and refined beam indices predicted by a machine learning model are received, wherein the machine learning model is trained to predict beam indices from sensor information. Thereafter, a refined BPL is established with the apparatus, based on the predicted the refined beam indices.

In one embodiment, the sensor information includes location information indicative of a location of the device. The sensor information may for example comprise of at least one from the group comprising of GPS information, barometric pressure, temperature, accelerometer input and device orientation.

According to a sixth aspect, there is provided a device for implementing the method according to the fifth aspect.

In one exemplary implementation, the device comprises a processing circuitry; and a memory circuitry storing computer program code which, when run in the processing circuitry, causes the device to perform beam management. The computer program code, when run in the processing circuitry, causes the device to establish an initial coarse Beam Pair Link (BPL) with an apparatus; and transmit information from at least one sensor to the apparatus. The computer program code, when run in the processing circuitry, further causes the device to receive refined beam indices predicted by a machine learning model, wherein the machine learning model is trained to predict beam indices from sensor information; and to establish a refined BPL with the apparatus, based on the predicted the refined beam indices.

In one embodiment, the device comprises at least one sensor circuitry sensing information which includes location information indicative of a location of the device. The at least one sensor may for example be at least one from the group comprising of a GPS sensor, a barometric sensor, a temperature sensor, an accelerometer and orientation sensor.

In one embodiment, the device is a User Equipment (UE).

According to a seventh aspect, there is provided a device. The device comprises means adapted to establish an initial coarse Beam Pair Link (BPL) with an apparatus. The device may further comprise means adapted to transmit information from at least one sensor to the apparatus and means adapted to receive refined beam indices predicted by a machine learning model, wherein the machine learning model is trained to predict beam indices from sensor information. The device may further comprise means adapted to establish a refined BPL with the apparatus, based on the predicted the refined beam indices.

According to an eight aspect, there is provided a device. The device comprises at least a first unit configured to establish an initial coarse BPL with an apparatus, and a second module configured to transmit information from at least one sensor to the apparatus. The device further comprises a third module configured to receive refined beam indices predicted by a machine learning model, wherein the machine learning model is trained to predict beam indices from sensor information; and a fourth module configured to establish a refined BPL with the apparatus, based on the predicted refined beam indices.

According to a ninth aspect, there is provided a computer program comprising instructions which, when executed on a processing circuitry, causes the processing circuitry to carry out the method according to the first aspect and/or the fifth aspect.

According to a tenth aspect, there is provided a carrier containing the computer program of the ninth aspect, wherein the carrier is one of an electronic signal, optical signal, radio signal, or computer readable storage medium.

The various proposed embodiments herein may reduce complexity, overhead and delay by prediction of refined BPLs in scenarios where beam indication and joint P2/P3 are required.

### BRIEF DESCRIPTION OF THE DRAWINGS

These and other aspects, features and advantages will be apparent and elucidated from the following description of various embodiments, reference being made to the accompanying drawings, wherein:

FIG. 1 is a message sequence chart of a beam management process;

FIG. 2 is a flowchart of an example method implemented by an apparatus;

FIG. 3 is a flow diagram according to one embodiment;

FIG. 4 shows an example implementation of an apparatus;

FIG. 5 shows a further example implementation of an apparatus;

FIG. 6 is a flowchart of an example method implemented by a device;

FIG. 7 shows an example implementation of a device;

FIG. 8 shows a further example implementation of a device;

FIG. 9 schematically illustrates a telecommunication network connected via an intermediate network to a host computer;

FIG. 10 is a generalized block diagram of a host computer communicating via a base station with a user equipment over a partially wireless connection;

FIGS. 11 to 12 are flowcharts illustrating transmitting-side methods implemented in a communication system including a host computer, a base station and a user equipment; and

FIGS. 13 to 14 are flowcharts illustrating receiving-side methods implemented in a communication system including a host computer, a base station and a user equipment.

### DETAILED DESCRIPTION

The present invention will now be described more fully hereinafter. The present invention may, however, be embodied in many different forms and should not be construed as limited to the embodiments set forth herein; rather, these embodiments are provided by way of example so that this disclosure will be thorough and complete, and will fully convey the scope of the invention to those persons skilled in the relevant art. Like reference numbers refer to like elements throughout the description.

In one of its aspects, the disclosure presented herein concerns a method for performing beam management.

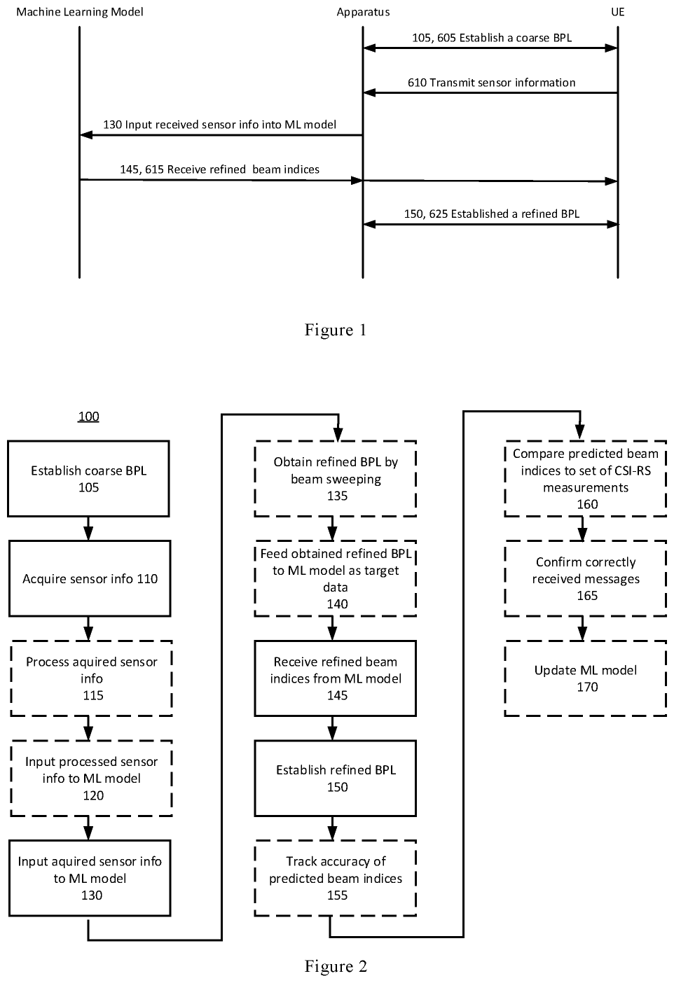

With reference to FIGS. 1 and 2, a first embodiment will now be described. FIG. 1 illustrates a message sequence chart of a beam management process, illustrating which messages/information that is sent between different entities in a system, and FIG. 2 illustrates a method, implemented by an apparatus, for performing beam management. The method may start in that an initial coarse Beam Pair Link (BPL) may be established 105 with a device. During this step, the apparatus and the device may synchronize. A coarse beam connection may be established. When this step is completed, the apparatus and the device may exchange messages using the established coarse beams.

Thereafter, information from at least one sensor at the device may be acquired 110. This information may provide useful information about the device and the environment surrounding the device, and may assist in the beam management. As most devices these days may comprise at least one sensor, the inventors have realized that it may be advantageous to make use of that information.

The acquired information may thereafter be input 130 into a machine learning model, wherein the machine learning model may be trained to predict beam indices from sensor information. A machine learning model may be a subset of artificial intelligence in the field of computer science that may use computational methods to “learn” information directly from data, without relying on a predetermined equation as a model or being explicitly programmed. A core objective of machine learning models may be to generalize from its experience. Generalization in this context may be the ability of a machine learning model to perform accurately on new, unseen examples or tasks after having experienced a learning data set, i.e. during a training mode. The training data generally contains the correct answer, which is known as target data and may come from some generally unknown probability distribution, which may be considered representative of the space of occurrences. The machine learning model may use the training data to build a general model about this space that may enable it to produce sufficiently accurate predictions in new cases. The machine learning model may adaptively improve its performance as the number of samples available for learning may increase.

Accordingly, with reference to above, the acquired information from the at least one sensor at the device may be input into the machine learning model. The machine learning model may have learned that certain sensor information may indicate certain conditions. The best BPL may have been introduced to the machine learning model in different situations where the information from the at least one sensor may have comprised different sensor information. Hence, the machine learning model may have learned how to predict the refined beam indices from this input information.

The data input into the machine learning model may vary depending on which information that may be acquired from the at least one sensor. The only constraint may be that the dimensions of the inputs and the outputs generally need to be fixed and remain the same for both the training mode and the prediction mode of the machine learning model.

The proposed method may be flexible to use with different machine learning models. The machine learning model may, for example, be a supervised learning model in training mode and an unsupervised learning method in the deployed, prediction mode. The machine learning model may, according to another example, be a supervised learning method in the deployed, prediction mode. Several different machine learning techniques may be used for the machine learning model, for example decision trees, random forests, neural networks, Recurrent Neural Networks (RNNs)/Long-Short Term Memory (LSTM) etc. For the unsupervised learning, simpler online methods may be used based on the current time instant or a more advanced learning techniques based on the current and past time instances. Reinforcement learning methods may also be used.

In RNNs, the output of a layer may be fed back to the input of the layer. This feedback may create a memory, similar to an Infinite Impulse Response (IIR) filter, which can take pervious decisions into account. A variety of the RNN is the LSTM. The LSTM may use a “cell” to store an information value, and three gates, such as input, output, and forget, to control the flow of information into and out of the cell.

In reinforcement learning, the machine learning model may take actions in its environment, and the best actions may be selected based on a cumulative reward, which may be evaluated with some delay. An advantage of reinforcement learning may be that the machine learning model can try new parameter settings not seen during the training phase and test them in a real environment. It may thus open for exploration and by different parameter settings, the system can balance between exploration of previously unexperienced settings, “uncharted territory”, and exploitation of current knowledge.

With reference to FIGS. 1 and 2 again, after that the acquired sensor information may have been input 130 into the machine learning model, the machine learning model may predict refined beam indices from the input information and the refined beam indices may be received 145 from the machine learning model. Based on the refined beam indices a refined BPL may be established 150 with the device. Hence, the need to perform a P2/P3 sweep may be mitigated as the refined beam indices may be predicted by the machine learning model and estimates of the refined transmitter and receiver beams may already be given.

Accordingly, with the above-described method, it may be possible to reduce complexity, overhead, and delay in scenarios where beam indication and joint P2/P3 may be required. This may be achieved as the general need to perform an exhaustive search through all of beams and perform P2 and P3 in an initial access situation may be mitigated, or reduced. By using information from at least one sensor and inputting this information into a machine learning model, refined beam indices may be predicted by the machine learning model based on the sensor information. The refined beam indices may be received from the machine learning model and the refined BPL may accordingly be established without performing an exhaustive search.

Some further embodiments will now be described with reference to FIG. 2. In one exemplary embodiment, the method may further comprise processing 115 the acquired sensor information and inputting 120 the processed sensor information into the machine learning model. The acquired sensor information may, for example, be processed by performing calculations. By processing the acquired sensor information, more information may be derived, and it may be facilitated for the machine learning model to predict the refined beam indices. This may, in some embodiments, reduce the need to acquire information from several sensors, thereby reducing complexity at the device by, for example, the numbers of sensor and the overall complexity, including signal processing computations. By performing a few simple calculations on the acquired information, it may, for example, be possible to derive the calculated best beams at the apparatus and the device. This information may also be input 120 into the machine learning model. All input information may thereafter be used by the machine learning model to predict the refined beam indices.

The acquired sensor information may in one embodiment include location information indicative of a location of the device. Hence, it may be possible for the machine learning model to anticipate the location of the device within a cell and thereby more easily predict the refined beam indices. The location information may for example be GPS coordinates, Wi-Fi signal strength, barometric pressure, temperature, accelerometer input, device orientation in space etc. This information may be useful to determine a “location fingerprint”. The angle and distance between the apparatus and the device, relative difference in barometric pressure and temperature etc. may be used to infer information about, for example, the prevailing type of scenario. The relative difference in barometric pressure between the apparatus and the device may indicate an altitude difference and may be used for beam identification. Temperature difference may give an indication of outdoor-to-indoor links, etc.

In some embodiments, information may be acquired from more than one sensor. This may ensure robustness. If, for example, GPS information may not be available at the moment of the coarse beamed connection at P1, the machine learning model may still be able to predict the refined beam pair indices based on the acquired sensor information. The information that may not be available for input into the machine learning model may be set to zero, or any other value that would not affect the computation in the machine learning mode. The value may be such that an unknown input does not affect the output from the machine learning model.

According to one embodiment, the acquired sensor information may also be used in beam tracking and beam selection updates. For example, if the acquired information from the at least one sensor, e.g. an accelerometer, at the device may indicate that the device is stationary, the BPL will remain unless external blocking or interference may occur. Hence, the beam tracking may be more “relaxed”. If the acquired information from the at least one sensor at the device may indicate movements, the direction may be signalled to the apparatus in order to facilitate inter-beam handover. A transition from stationary to moving may trigger a faster beam update.

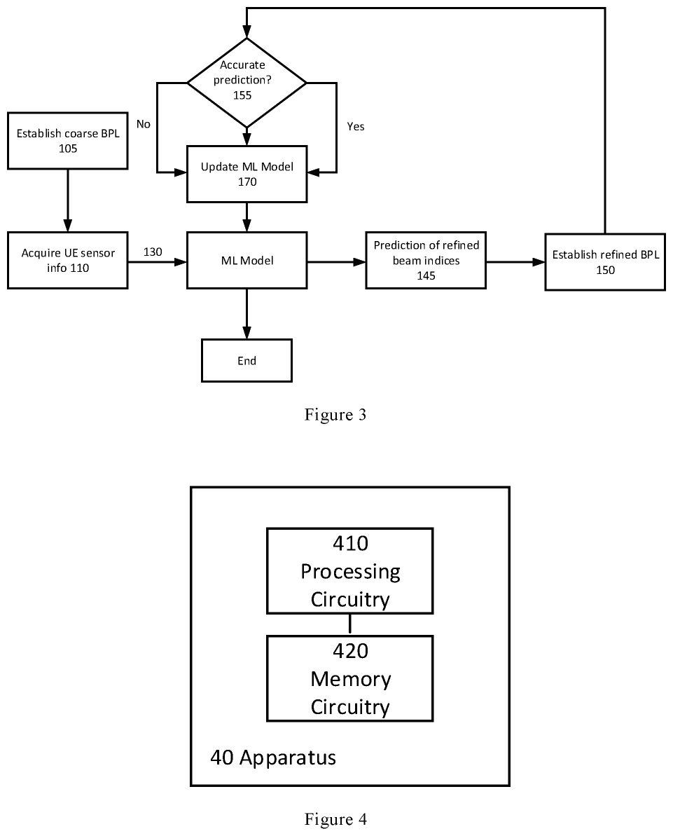

In one further embodiment, which is also illustrated in FIGS. 2 and 3, the method may comprise tracking 155 accuracy of the predicted beam indices and updating 170 the machine learning model in accordance with the tracked accuracy. By tracking 155 the accuracy of the predicted beam indices, it may be possible to check and determine whether the predictions made by the machine learning model were correct, i.e. accurate, or not. This may give an indication of how well the machine learning model is performing by tracking the level of uncertainty (environment stability) of predictions. It is typically important to maintain reliable estimates during deployment of the method and accordingly, the trained machine learning model may continuously be updated based on the uncertainty of the estimates. As known in the art, a reward may be given based on whether the estimates from the machine learning model were correct. The machine learning model may be updated according to the reward. Hence, the predicted refined beam indices may maintain reliability in case something in the environment may change.

Tracking 155 accuracy of the predicted beam indices may, for example, comprise comparing 160 the predicted beam indices to a set of strongest Channel State Information Reference Symbol (CSI-RS) measurements received from the device. Typically, the device may be required to send several of the strongest CSI-RS measurements. This information may be used to check the accuracy of the predicted beam indices. If the predicted beams belong to the same set of strongest beams reported by the device, the accuracy of the predicted beam indices may be good and a positive reward may be given. The uncertainty of the estimate is thus generally low. However, it may be appreciated that different reward functions may be used, but rewards are described herein in terms of positive and negative for simplicity.

According to another example, tracking 155 accuracy of the predicted beam indices may comprise confirming 165 whether messages between the apparatus and the device were received correctly using acknowledgement/negative-acknowledgement (ACK/NACK) information. It may be checked and determined whether the messages were received correctly, by using the received ACK/NACK information. If the prediction was correct, a positive reward may be given. If the prediction was incorrect, a negative reward may be given.

According to still another example, both ACK/NACK information and CSI-RS measurements may be used to track the accuracy of the predicted beam indices.

In one embodiment, when the machine learning model is in a training mode, the method may further comprise obtaining 135 a refined BPL by refining the initial coarse BPL by beam sweeping. The obtained refined BPL may be used as target data for the machine learning model and the method may further comprise feeding 140 the machine learning model with the obtained target data. Accordingly, during the training mode, the machine learning model may run normally by sweeping P2/P3 until refined beam indices have been obtained from P3. The machine learning model may receive this data as target data and may use it in the training to predict refined beam indices. Accordingly, in a training mode, all the procedures, P1/P2/P3, with beam indication, joint sweep, may be performed to acquire the target data. These steps may be repeated until the machine learning model may have been trained and learned how to predict refined beam indices from acquired sensor information.

In one embodiment, the machine learning model may be located separately and remotely from the apparatus. The machine learning model may, for example, be located within a computer server system comprising one or more computer servers. In another example, the machine learning model may be internal to the apparatus. In accordance with these described embodiments, the proposed method may provide a flexible solution for performing beam management as the machine learning model may be located wherever it may be the most suitable, depending on prevailing conditions or constraints.

Furthermore, the machine learning model may be trained at the apparatus and the device may transmit the required information to the apparatus, or the machine learning model may be trained remotely, at sites with more capabilities if this is required. In one embodiment, the machine learning model may be trained in a cloud. The weights of the trained machine learning model may then be sent to the place of execution. The machine learning model may be run at the apparatus or in the device, if complexity is at a reasonable level. There may be some extra signalling involved and to maintain learning online, the weights of the model may have to be updated. An advantage with a cloud implementation is that data may be shared between different machine learning models, i.e. models for different links. This may allow for a faster training mode by establishing a common model based on all available input. During the prediction mode, separate models may be used for each site and link. The model corresponding to a particular site may be updated based on the accuracy of data at that site, e.g. ACK/NACK. Accordingly, the machine learning model may be optimized to the specific characteristic of the site.

Furthermore, it may be appreciated that the proposed method may be suitable for different beamforming schemes such as analogue beamforming and hybrid-beamforming and is not in any way limited to a certain beamforming scheme.

According to a second aspect, there is provided an apparatus for implementing the method according to the first aspect.

FIG. 4 discloses an example implementation of an apparatus 40, which may be configured to perform the above-mentioned method. The apparatus 40 may comprise a processor, or a processing circuitry 410, and a memory, or a memory circuitry 420. The memory circuitry 420 may store computer program code which, when run in the processing circuitry 410, may cause the apparatus 40 to perform beam management.

In one exemplary embodiment, the computer program code, when run in the processing circuitry 410, may cause the apparatus 40 to establish an initial coarse BPL with a device. The apparatus 40 may then be caused to acquire information from at least one sensor at the device and to input the acquired information into a machine learning model. The machine learning model may be trained to predict beam indices from sensor information. Thereafter, the apparatus 40 is caused to receive, from the machine learning model, refined beam indices, wherein the machine learning model has predicted the refined beam indices from the input information; and establish a refined BPL with the device, based on the predicted refined beam indices.

In one exemplary embodiment, the memory circuitry 420 may store computer program code which, when run in the processing circuitry 410, may cause the apparatus 40 to train the machine learning model by process the acquired sensor information and input the processed sensor information into the machine learning model.

In one embodiment, the acquired sensor information may include location information indicative of a location of the device.

In one embodiment, the memory circuitry 420 may store computer program code which, when run in the processing circuitry 410, may cause the apparatus 40 to track accuracy of the predicted beam indices and update the machine learning model in accordance with the tracked accuracy. According to one example, the memory circuitry 420 may store computer program code which, when run in the processing circuitry 410, may cause the apparatus 40 to track accuracy of the predicted beam indices by comparing the predicted beam indices to a set of strongest CSI-RS measurements received from the device. According to another example, the memory circuitry 420 may store computer program code which, when run in the processing circuitry 410, may cause the apparatus 40 to track accuracy of the predicted beam indices by confirming whether messages between the apparatus and the device were received correctly using ACK/NACK information.

In one embodiment, the machine learning model may be located separately and remotely from the apparatus 40. The machine learning model may for example be located within a computer server system comprising one or more computer servers. In another embodiment, the machine learning model may be internal to the apparatus 40. The machine learning model may accordingly be located, i.e. stored, either separately and remotely from the apparatus 40, or located, i.e. stored, internal to the apparatus 40. Thus, information about the model type, structure, and relevant parameters may be stored where the machine learning model may be located.

According to one embodiment, the apparatus 40 may be a transmission point. The apparatus may for example be a base station.

In one embodiment, the memory circuitry 420 may store computer program code which, when run in the processing circuitry 410 and when the machine learning model is in a training mode, may cause the apparatus 40 to obtain a refined BPL by refining the initial coarse BPL by beam sweeping, wherein the obtained refined BPL is used as target data for the machine learning model; and feed the machine learning model with the obtained target data.

According to one embodiment, the initial access procedure P1 may be made more efficient by learning the environment where the apparatus is operating. Different machine learning models may be used for different apparatuses, i.e. for different sites. Sites may typically have different environments and having separate machine learning models per site may be advantageous as the machine learning model may be able to learn its environment. The machine learning model may learn the BPL determined by P3 that may be most commonly used depending on what information is acquired from at least one sensor at the device at that particular position.

According to a third aspect, there is provided an apparatus. The apparatus may comprise means adapted to establish an initial coarse Beam Pair Link, BPL, with a device. The apparatus may further comprise means adapted to acquire information from at least one sensor at the device, and means adapted to input the acquired information into a machine learning model, wherein the machine learning model may be trained to predict beam indices from sensor information. The apparatus may further comprise means adapted to receive, from the machine learning model, refined beam indices, wherein the machine learning model may have predicted the refined beam indices from the input information, and means adapted to establish a refined BPL with the device, based on the predicted refined beam indices.

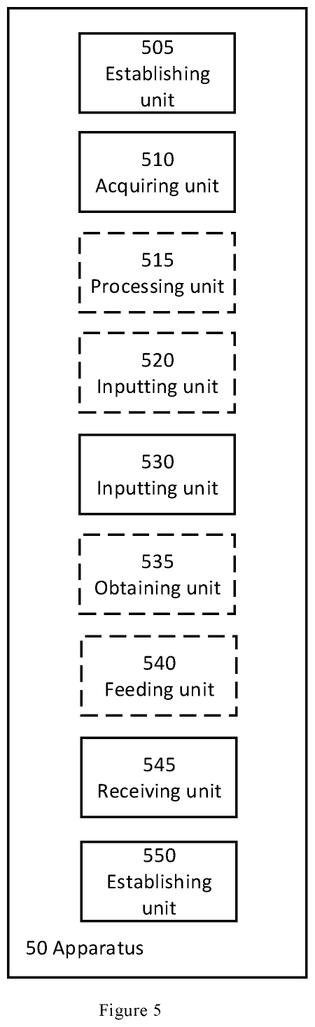

According to a fourth aspect, as illustrated in FIG. 5, there is provided an apparatus 50. The apparatus 50 may comprise at least five modules. The apparatus 50 may comprise a first module 505 configured to establish an initial coarse BPL with a device, and a second module 510 configured to acquire information from at least one sensor at the device. The apparatus further comprises a third module 530 configured to input the acquired information into a machine learning model, wherein the machine learning model is trained to predict beam indices from sensor information, a fourth module 545 configured to receive, from the machine learning model, refined beam indices, wherein the machine learning model has predicted the refined beam indices from the input information, and a fifth module 550 configured to establish a refined BPL with the device, based on the predicted refined beam indices.

In one exemplary embodiment, the apparatus 50 may further comprise a processing module 515 configured to process the acquired sensor information and the apparatus 50 may further comprise an inputting unit 520 configured to input the processed sensor information into the machine learning model.

In one exemplary embodiment, the apparatus 50 may further comprise an obtaining unit configured to obtain a refined BPL by refining the initial coarse BPL by beam sweeping, wherein the obtained refined BPL is used as target data for the machine learning model and a feeding unit 540 configure to feed the machine learning model with the obtained target data.

According to a fifth aspect, the disclosure presented herein concerns a method for performing beam management. The method may be implemented by a device.

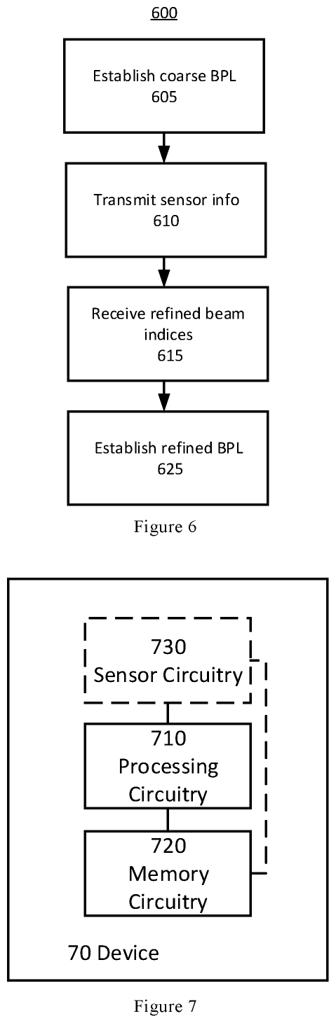

With reference to the FIGS. 1 and 6, an embodiment will now be described. FIG. 6 illustrates a method implemented by a device. The method may comprise establishing 605 an initial coarse Beam Pair Link, BPL, with an apparatus. Thereafter, information from at least one sensor may be transmitted 610 to the apparatus. Refined beam indices predicted by a machine learning model may be received 615. The machine learning model may be trained to predict beam indices from sensor information. Thereafter, a refined BPL may be established 625 with the apparatus, based on the predicted the refined beam indices.

In one embodiment, the sensor information may include location information indicative of a location of the device. The sensor information may, for example, comprise of at least one from the group comprising of GPS information, barometric pressure, temperature, accelerometer input and device orientation.

According to a sixth aspect, there is provided a device for implementing the method according to the fifth aspect.

FIG. 7, discloses an example implementation of a device 70, which may be configured to perform the above-described method. The device 70 may comprise a processing circuitry 710 and a memory circuitry 720. The memory circuitry 720 may store computer program code which, when run in the processing circuitry 710, may cause the device 70 to perform beam management.

In one exemplary embodiment, the computer program code, when run in the processing circuitry 710, may cause the device 70 to establish an initial coarse BPL with an apparatus. The computer program code, when run in the processing circuitry 710, may further cause the device 70 to transmit information from at least one sensor to the apparatus. The device 70 may be caused to receive refined beam indices predicted by a machine learning model, wherein the machine learning model is trained to predict beam indices from sensor information. The computer program code, when run in the processing circuitry 710, may then cause the device 70 to establish a refined BPL with the apparatus, based on the predicted refined beam indices.

In one embodiment, the device 70 may comprise at least one sensor circuitry 730 sensing information which includes location information indicative of a location of the device. The at least one sensor may for example be at least one from the group comprising of a GPS sensor, a barometric sensor, a temperature sensor, an accelerometer and orientation sensor. The sensor capabilities of the device 70 may be given in standardized categories, similar to device categories in present standards, or explicitly signalled as a list of sensors, or exchanged in any other suitable mode, e.g. handed over between apparatuses using X2 or similar.

In one embodiment, the device 70 may be a User Equipment (UE).

As described previously, the machine learning model may have the constraint that the dimensions of the inputs and the outputs need to be fixed and remain the same for both the training mode and the prediction mode. However, the information that is not available for input into the machine learning model may be set to zero, or any other value that would not affect the computation in the machine learning mode. Accordingly, an unknown input may not affect the output from the machine learning model and the proposed device may be any device ranging from “smart” UEs with a wide sensor suite to simpler devices comprising only one or a few sensors.

According to a seventh aspect, there is provided a device. The device may comprise means adapted to establish an initial coarse Beam Pair Link (BPL) with an apparatus. The device may further comprise means adapted to transmit information from at least one sensor to the apparatus and means adapted to receive refined beam indices predicted by a machine learning model, wherein the machine learning model is trained to predict beam indices from sensor information. The device may further comprise means adapted to establish a refined BPL with the apparatus, based on the predicted the refined beam indices.

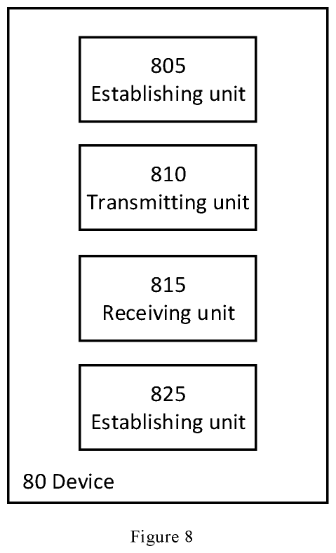

According to an eight aspect, there is provided a device 80 as illustrated in FIG. 8. The device may comprise at least a first unit 805 configured to establish an initial coarse BPL with an apparatus, and a second module 810 configured to transmit information from at least one sensor to the apparatus. The device may further comprise a third module 815 configured to receive refined beam indices predicted by a machine learning model, wherein the machine learning model may be trained to predict beam indices from sensor information; and a fourth module 825 configured to establish a refined BPL with the apparatus, based on the predicted the refined beam indices.

According to a ninth aspect, there is provided a computer program comprising instructions which, when executed on a processing circuitry, may cause the processing circuitry to carry out the method according to the first aspect and/or the fifth aspect.

According to a tenth aspect, there is provided a carrier containing the computer program of the ninth aspect, wherein the carrier may be one of an electronic signal, optical signal, radio signal, or computer readable storage medium.

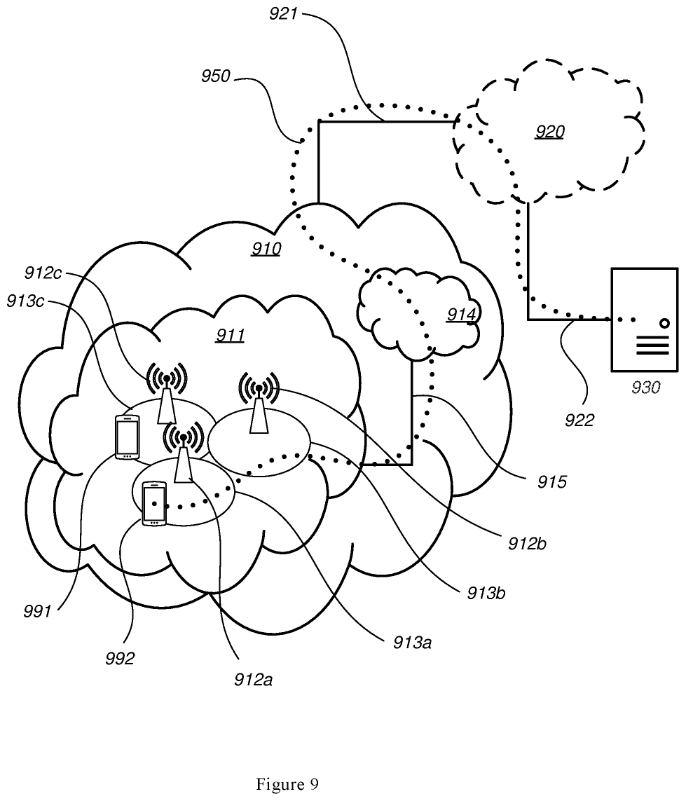

With reference to FIG. 9, in accordance with an embodiment, a communication system includes a telecommunication network 910, such as a 3GPP-type cellular network, which comprises an access network 911, such as a radio access network, and a core network 914. The access network 911 comprises a plurality of base stations 912a, 912b, 912c, such as NBs, eNBs, gNBs or other types of wireless access points, each defining a corresponding coverage area 913a, 913b, 913c. Each base station 912a, 912b, 912c is connectable to the core network 914 over a wired or wireless connection 915. A first user equipment (UE) 991 located in coverage area 913c is configured to wirelessly connect to, or be paged by, the corresponding base station 912c. A second UE 992 in coverage area 913a is wirelessly connectable to the corresponding base station 912a. While a plurality of UEs 991, 992 are illustrated in this example, the disclosed embodiments are equally applicable to a situation where a sole UE is in the coverage area or where a sole UE is connecting to the corresponding base station 912.

The telecommunication network 910 is itself connected to a host computer 930, which may be embodied in the hardware and/or software of a standalone server, a cloud-implemented server, a distributed server or as processing resources in a server farm. The host computer 930 may be under the ownership or control of a service provider, or may be operated by the service provider or on behalf of the service provider. The connections 921, 922 between the telecommunication network 910 and the host computer 930 may extend directly from the core network 914 to the host computer 930 or may go via an optional intermediate network 920. The intermediate network 920 may be one of, or a combination of more than one of, a public, private or hosted network; the intermediate network 920, if any, may be a backbone network or the Internet; in particular, the intermediate network 920 may comprise two or more sub-networks (not shown).

The communication system of FIG. 9 as a whole enables connectivity between one of the connected UEs 991, 992 and the host computer 930. The connectivity may be described as an over-the-top (OTT) connection 950. The host computer 930 and the connected UEs 991, 992 are configured to communicate data and/or signalling via the OTT connection 950, using the access network 911, the core network 914, any intermediate network 920 and possible further infrastructure (not shown) as intermediaries. The OTT connection 950 may be transparent in the sense that the participating communication devices through which the OTT connection 950 passes are unaware of routing of uplink and downlink communications. For example, a base station 912 may not or need not be informed about the past routing of an incoming downlink communication with data originating from a host computer 930 to be forwarded (e.g., handed over) to a connected UE 991. Similarly, the base station 912 need not be aware of the future routing of an outgoing uplink communication originating from the UE 991 towards the host computer 930.

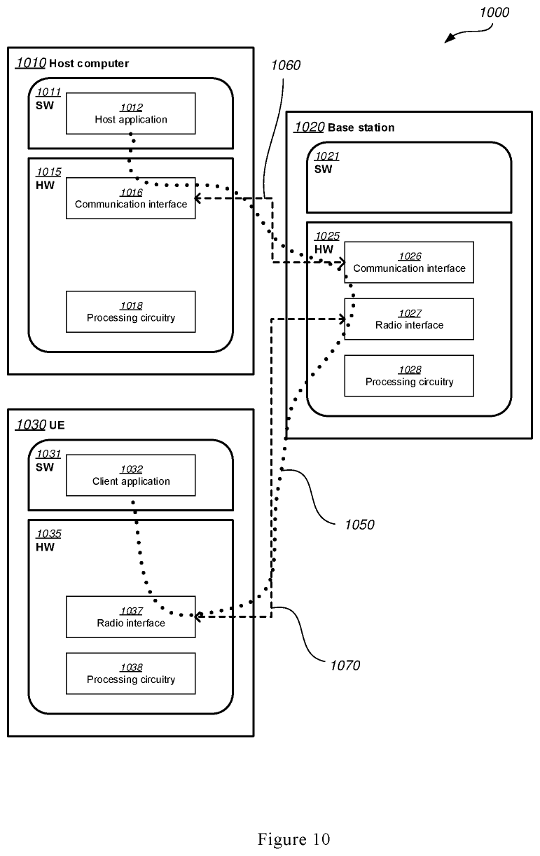

Example implementations, in accordance with an embodiment, of the UE, base station and host computer discussed in the preceding paragraphs will now be described with reference to FIG. 10. In a communication system 1000, a host computer 1010 comprises hardware 1015 including a communication interface 1016 configured to set up and maintain a wired or wireless connection with an interface of a different communication device of the communication system 1000. The host computer 1010 further comprises processing circuitry 1018, which may have storage and/or processing capabilities. In particular, the processing circuitry 1018 may comprise one or more programmable processors, application-specific integrated circuits, field programmable gate arrays or combinations of these (not shown) adapted to execute instructions. The host computer 1010 further comprises software 1011, which is stored in or accessible by the host computer 1010 and executable by the processing circuitry 1018. The software 1011 includes a host application 1012. The host application 1012 may be operable to provide a service to a remote user, such as a UE 1030 connecting via an OTT connection 950 terminating at the UE 930 and the host computer 910. In providing the service to the remote user, the host application 1012 may provide user data which is transmitted using the OTT connection 1050.

The communication system 1000 further includes a base station 1020 provided in a telecommunication system and comprising hardware 1025 enabling it to communicate with the host computer 1010 and with the UE 1030. The hardware 1025 may include a communication interface 1026 for setting up and maintaining a wired or wireless connection with an interface of a different communication device of the communication system 1000, as well as a radio interface 1027 for setting up and maintaining at least a wireless connection 1070 with a UE 1030 located in a coverage area (not shown in FIG. 10) served by the base station 1020. The communication interface 1026 may be configured to facilitate a connection 1060 to the host computer 1010. The connection 1060 may be direct or it may pass through a core network (not shown in FIG. 10) of the telecommunication system and/or through one or more intermediate networks outside the telecommunication system. In the embodiment shown, the hardware 1025 of the base station 1020 further includes processing circuitry 1028, which may comprise one or more programmable processors, application-specific integrated circuits, field programmable gate arrays or combinations of these (not shown) adapted to execute instructions. The base station 1020 further has software 1021 stored internally or accessible via an external connection.

The communication system 1000 further includes the UE 1030 already referred to. Its hardware 1035 may include a radio interface 1037 configured to set up and maintain a wireless connection 1070 with a base station serving a coverage area in which the UE 1030 is currently located. The hardware 1035 of the UE 1030 further includes processing circuitry 1038, which may comprise one or more programmable processors, application-specific integrated circuits, field programmable gate arrays or combinations of these (not shown) adapted to execute instructions. The UE 1030 further comprises software 1031, which is stored in or accessible by the UE 1030 and executable by the processing circuitry 1038. The software 1031 includes a client application 1032. The client application 1032 may be operable to provide a service to a human or non-human user via the UE 1030, with the support of the host computer 1010. In the host computer 1010, an executing host application 1012 may communicate with the executing client application 1032 via the OTT connection 950 terminating at the UE 930 and the host computer 910. In providing the service to the user, the client application 1032 may receive request data from the host application 1012 and provide user data in response to the request data. The OTT connection 1050 may transfer both the request data and the user data. The client application 1032 may interact with the user to generate the user data that it provides.

It is noted that the host computer 1010, base station 1020 and UE 1030 illustrated in FIG. 10 may be identical to the host computer 930, one of the base stations 912a, 912b, 912c and one of the UEs 991, 992 of FIG. 9, respectively. This is to say, the inner workings of these entities may be as shown in FIG. 10 and independently, the surrounding network topology may be that of FIG. 9.

In FIG. 10, the OTT connection 1050 has been drawn abstractly to illustrate the communication between the host computer 1010 and the use equipment 1030 via the base station 1020, without explicit reference to any intermediary devices and the precise routing of messages via these devices. Network infrastructure may determine the routing, which it may be configured to hide from the UE 1030 or from the service provider operating the host computer 1010, or both. While the OTT connection 1050 is active, the network infrastructure may further take decisions by which it dynamically changes the routing (e.g., on the basis of load balancing consideration or reconfiguration of the network).

The wireless connection 1070 between the UE 1030 and the base station 1020 is in accordance with the teachings of the embodiments described throughout this disclosure. One or more of the various embodiments improve the performance of OTT services provided to the UE 1030 using the OTT connection 1050, in which the wireless connection 1070 forms the last segment. More precisely, the teachings of these embodiments may improve the data rate and latency and thereby provide benefits such as reduced user waiting time and better responsiveness.

A measurement procedure may be provided for the purpose of monitoring data rate, latency and other factors on which the one or more embodiments improve. There may further be an optional network functionality for reconfiguring the OTT connection 1050 between the host computer 1010 and UE 1030, in response to variations in the measurement results. The measurement procedure and/or the network functionality for reconfiguring the OTT connection 1050 may be implemented in the software 1011 of the host computer 1010 or in the software 1031 of the UE 1030, or both. In embodiments, sensors (not shown) may be deployed in or in association with communication devices through which the OTT connection 1050 passes; the sensors may participate in the measurement procedure by supplying values of the monitored quantities exemplified above, or supplying values of other physical quantities from which software 1011, 1031 may compute or estimate the monitored quantities. The reconfiguring of the OTT connection 1050 may include message format, retransmission settings, preferred routing etc.; the reconfiguring need not affect the base station 1020, and it may be unknown or imperceptible to the base station 1020. Such procedures and functionalities may be known and practiced in the art. In certain embodiments, measurements may involve proprietary UE signaling facilitating the host computer's 1010 measurements of throughput, propagation times, latency and the like. The measurements may be implemented in that the software 1011, 1031 causes messages to be transmitted, in particular empty or ‘dummy’ messages, using the OTT connection 1050 while it monitors propagation times, errors etc.

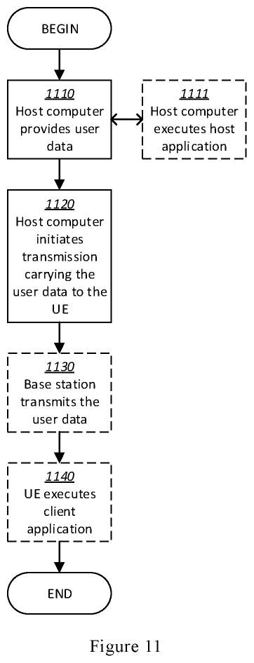

FIG. 11 is a flowchart illustrating a method implemented in a communication system, in accordance with one embodiment. The communication system includes a host computer, a base station and a UE which may be those described with reference to FIGS. 9 and 10. For simplicity of the present disclosure, only drawing references to FIG. 11 will be included in this section. In a first step 1110 of the method, the host computer provides user data. In an optional substep 1111 of the first step 1110, the host computer provides the user data by executing a host application. In a second step 1120, the host computer initiates a transmission carrying the user data to the UE. In an optional third step 1130, the base station transmits to the UE the user data which was carried in the transmission that the host computer initiated, in accordance with the teachings of the embodiments described throughout this disclosure. In an optional fourth step 1140, the UE executes a client application associated with the host application executed by the host computer.

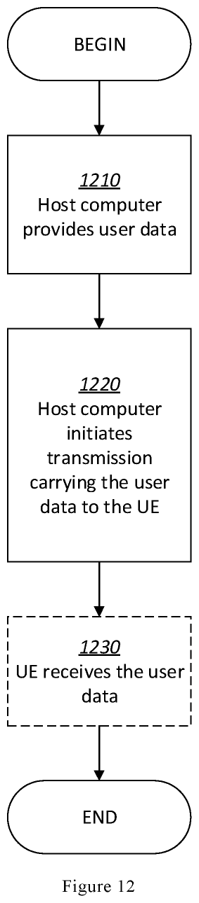

FIG. 12 is a flowchart illustrating a method implemented in a communication system, in accordance with one embodiment. The communication system includes a host computer, a base station and a UE which may be those described with reference to FIGS. 9 and 10. For simplicity of the present disclosure, only drawing references to FIG. 12 will be included in this section. In a first step 1210 of the method, the host computer provides user data. In an optional substep (not shown) the host computer provides the user data by executing a host application. In a second step 1220, the host computer initiates a transmission carrying the user data to the UE. The transmission may pass via the base station, in accordance with the teachings of the embodiments described throughout this disclosure. In an optional third step 1230, the UE receives the user data carried in the transmission.

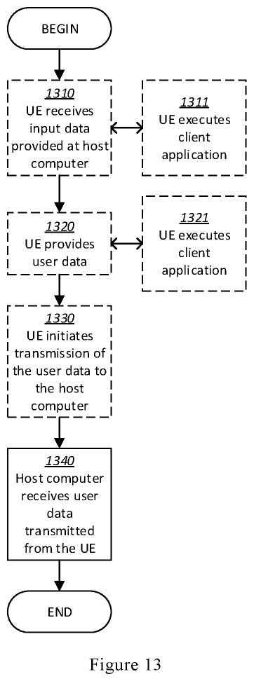

FIG. 13 is a flowchart illustrating a method implemented in a communication system, in accordance with one embodiment. The communication system includes a host computer, a base station and a UE which may be those described with reference to FIGS. 9 and 10. For simplicity of the present disclosure, only drawing references to FIG. 13 will be included in this section. In an optional first step 1310 of the method, the UE receives input data provided by the host computer. Additionally or alternatively, in an optional second step 1320, the UE provides user data. In an optional substep 1321 of the second step 1320, the UE provides the user data by executing a client application. In a further optional substep 1311 of the first step 1310, the UE executes a client application which provides the user data in reaction to the received input data provided by the host computer. In providing the user data, the executed client application may further consider user input received from the user. Regardless of the specific manner in which the user data was provided, the UE initiates, in an optional third substep 1330, transmission of the user data to the host computer. In a fourth step 1340 of the method, the host computer receives the user data transmitted from the UE, in accordance with the teachings of the embodiments described throughout this disclosure.

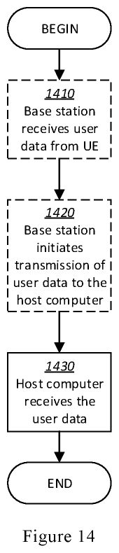

FIG. 14 is a flowchart illustrating a method implemented in a communication system, in accordance with one embodiment. The communication system includes a host computer, a base station and a UE which may be those described with reference to FIGS. 9 and 10. For simplicity of the present disclosure, only drawing references to FIG. 14 will be included in this section. In an optional first step 1410 of the method, in accordance with the teachings of the embodiments described throughout this disclosure, the base station receives user data from the UE. In an optional second step 1420, the base station initiates transmission of the received user data to the host computer. In a third step 1430, the host computer receives the user data carried in the transmission initiated by the base station.

### Numbered Embodiments in Particular Related to FIGS. 9-14

1. A base station configured to communicate with a user equipment (UE), the base station comprising a radio interface and processing circuitry configured to performing beam management, wherein the base station is configured to:
establish an initial coarse Beam Pair Link (BPL) with a device,
acquire information from at least one sensor at the device;
input the acquired information into a machine learning model, wherein the machine learning model is trained to predict beam indices from sensor information;
receive, from the machine learning model, refined beam indices, wherein the machine learning model has predicted the refined beam indices from the input information; and
establish a refined BPL with the device, based on the predicted refined beam indices.
   2. The base station of embodiment 1, further configured to:
process the acquired sensor information; and
input the processed sensor information into the machine learning model.
   3. The base station of any of embodiment 1 or 2, wherein the acquired sensor information includes location information indicative of a location of the device.
   4. The base station of any of embodiments 1 to 3, further configured to:
track accuracy of the predicted beam indices; and
update the machine learning model in accordance with the tracked accuracy.
   5. The base station of any of embodiment 4, wherein the base station is configured to track accuracy of the predicted beam indices by:
compare the predicted beam indices to a set of strongest Channel State Information Reference Symbol (CSI-RS) measurements received from the device.
   6. The base station of any of embodiment 4, wherein the base station is configured to track accuracy of the predicted beam indices by:
confirm whether messages between the apparatus and the device were received correctly using ACK/NACK information.
   7. The base station of any of embodiments 1 to 6, wherein the machine learning model is located separately and remotely from the base station.
   8. The base station of any of embodiment 7, wherein the machine learning model is located within a computer server system comprising one or more computer servers
   9. The base station of any of embodiments 1 to 6, wherein the machine learning model is internal to the base station.
   10. The base station of any of embodiments 1 to 9, wherein the base station is configured to:
obtain a refined BPL by refining the initial coarse BPL by beam sweeping, wherein the obtained refined BPL is used as target data for the machine learning model; and
feed the machine learning model with the obtained target data.
   11. A communication system including a host computer comprising:

processing circuitry configured to provide user data; and

a communication interface configured to forward the user data to a cellular network for transmission to a user equipment (UE),

wherein the cellular network comprises a base station having a radio interface and processing circuitry, the base station's processing circuitry configured to:
establish an initial coarse Beam Pair Link (BPL) with a device,
acquire information from at least one sensor at the device;
input the acquired information into a machine learning model, wherein the machine learning model is trained to predict beam indices from sensor information;
receive, from the machine learning model, refined beam indices, wherein the machine learning model has predicted the refined beam indices from the input information; and
establish a refined BPL with the device, based on the predicted refined beam indices.
   12. The communication system of embodiment 11, further including the base station.
   13. The communication system of embodiment 12, further including the UE, wherein the UE is configured to communicate with the base station.
   14. The communication system of embodiment 13, wherein:
the processing circuitry of the host computer is configured to execute a host application, thereby providing the user data; and
the UE comprises processing circuitry configured to execute a client application associated with the host application.
   15. A method implemented in a base station, comprising
establishing an initial coarse Beam Pair Link (BPL) with a device,
acquiring information from at least one sensor at the device;
inputting the acquired information into a machine learning model, wherein the machine learning model is trained to predict beam indices from sensor information;
receiving, from the machine learning model, refined beam indices, wherein the machine learning model has predicted the refined beam indices from the input information; and
establishing a refined BPL with the device, based on the predicted refined beam indices.
   16. The method of embodiment 15, wherein the method further comprises:
processing the acquired sensor information; and
inputting the processed sensor information into the machine learning model.
   17. The method of any of embodiment 15 or 16, wherein the acquired sensor information includes location information indicative of a location of the device.
   18. The method of any of embodiments 15 to 17, wherein the method further comprises:
tracking accuracy of the predicted beam indices; and
updating the machine learning model in accordance with the tracked accuracy.
   19. The method of embodiment 18, wherein tracking accuracy of the predicted beam indices comprises:
comparing the predicted beam indices to a set of strongest Channel State Information Reference Symbol (CSI-RS) measurements received from the device.
   20. The method of embodiment 18, wherein tracking accuracy of the predicted beam indices comprises:
confirming whether messages between the apparatus and the device were received correctly using ACK/NACK information.
   21. The method of any of embodiments 15 to 20, wherein the method, when the machine learning model is in a training mode, further comprises;
obtaining a refined BPL by refining the initial coarse BPL by beam sweeping, wherein the obtained refined BPL is used as target data for the machine learning model; and
feeding the machine learning model with the obtained target data
   22. The method of any of embodiments 15 to 21, wherein the machine learning model is located separately and remotely from the apparatus.
   23. The method of embodiment 22, wherein the machine learning model is located within a computer server system comprising one or more computer servers.
   24. The method of any of embodiments 15 to 21, wherein the machine learning model is internal to the base station.
   25. A method implemented in a communication system including a host computer, a base station and a user equipment (UE), the method comprising:

at the host computer, providing user data; and

at the host computer, initiating a transmission carrying the user data to the UE via a cellular network comprising the base station, wherein the base station performs beam management by:
establishing an initial coarse Beam Pair Link (BPL) with a device,
acquiring information from at least one sensor at the device;
inputting the acquired information into a machine learning model, wherein the machine learning model is trained to predict beam indices from sensor information;
receiving, from the machine learning model, refined beam indices, wherein the machine learning model has predicted the refined beam indices from the input information; and
establishing a refined BPL with the device, based on the predicted refined beam indices.
   26. The method of embodiment 25, further comprising:
at the base station, transmitting the user data.
   27. The method of embodiment 26, wherein the user data is provided at the host computer by executing a host application, the method further comprising:
at the UE, executing a client application associated with the host application.
   28. A user equipment (UE) configured to communicate with a base station, the UE comprising a radio interface and processing circuitry configured to:
establish an initial coarse Beam Pair Link (BPL) with an apparatus;
transmit information from at least one sensor to the apparatus;
receive refined beam indices predicted by a machine learning model, wherein the machine learning model is trained to predict beam indices from sensor information; and
establish a refined BPL with the apparatus, based on the predicted the refined beam indices.
   29. The UE of embodiment 28, wherein the device comprises at least one sensor circuitry sensing information which includes location information indicative of a location of the UE.
   30. The UE of embodiment 29, wherein the at least one sensor is at least one from the group comprising of a GPS sensor, a barometric sensor, a temperature sensor, an accelerometer and orientation sensor.
   31. A communication system including a host computer comprising:

processing circuitry configured to provide user data; and

a communication interface configured to forward user data to a cellular network for transmission to a user equipment (UE),

wherein the UE comprises a radio interface and processing circuitry, the UE's processing circuitry configured to:
establish an initial coarse Beam Pair Link (BPL) with an apparatus;
transmit information from at least one sensor to the apparatus;
receive refined beam indices predicted by a machine learning model, wherein the machine learning model is trained to predict beam indices from sensor information; and
establish a refined BPL with the apparatus, based on the predicted the refined beam indices.
   32. The communication system of embodiment 31, further including the UE.
   33. The communication system of embodiment 32, wherein the cellular network further includes a base station configured to communicate with the UE.
   34. The communication system of embodiment 32 or 33, wherein:
the processing circuitry of the host computer is configured to execute a host application, thereby providing the user data; and
the UE's processing circuitry is configured to execute a client application associated with the host application.
   35. A method implemented in a user equipment (UE), comprising:
establishing an initial coarse Beam Pair Link (BPL) with an apparatus;
transmitting information from at least one sensor to the apparatus;
receiving refined beam indices predicted by a machine learning model, wherein the machine learning model is trained to predict beam indices from sensor information; and
establishing a refined BPL with the apparatus, based on the predicted the refined beam indices.
   36. The method of embodiment 35, wherein the sensor information includes location information indicative of a location of the UE.
   37. The method of embodiment 36, wherein the sensor information is comprising of at least one from the group comprising of GPS information, barometric pressure, temperature, accelerometer input and device orientation.
   38. A method implemented in a communication system including a host computer, a base station and a user equipment (UE), the method comprising:

at the host computer, providing user data; and

at the host computer, initiating a transmission carrying the user data to the UE via a cellular network comprising the base station, wherein the UE:
establishing an initial coarse Beam Pair Link (BPL) with an apparatus;
transmitting information from at least one sensor to the apparatus;
receiving refined beam indices predicted by a machine learning model, wherein the machine learning model is trained to predict beam indices from sensor information; and
establishing a refined BPL with the apparatus, based on the predicted the refined beam indices.
   39. The method of embodiment 38, further comprising:
at the UE, receiving the user data from the base station.
   40. A communication system including a host computer comprising:

a communication interface configured to receive user data originating from a transmission from a user equipment (UE) to a base station,

wherein the UE comprises a radio interface and processing circuitry, the UE's processing circuitry configured to:
establish an initial coarse Beam Pair Link (BPL) with an apparatus;
transmit information from at least one sensor to the apparatus;
receive refined beam indices predicted by a machine learning model, wherein the machine learning model is trained to predict beam indices from sensor information; and
establish a refined BPL with the apparatus, based on the predicted the refined beam indices.
   41. The communication system of embodiment 40, further including the UE.
   42. The communication system of embodiment 41, further including the base station, wherein the base station comprises a radio interface configured to communicate with the UE and a communication interface configured to forward to the host computer the user data carried by a transmission from the UE to the base station.
   43. The communication system of embodiment 41 or 42, wherein:
the processing circuitry of the host computer is configured to execute a host application; and
the UE's processing circuitry is configured to execute a client application associated with the host application, thereby providing the user data.
   44. The communication system of embodiment 41 or 42, wherein:
the processing circuitry of the host computer is configured to execute a host application, thereby providing request data; and
the UE's processing circuitry is configured to execute a client application associated with the host application, thereby providing the user data in response to the request data.
   45. A method implemented in a user equipment (UE), comprising:
establishing an initial coarse Beam Pair Link (BPL) with an apparatus;
transmitting information from at least one sensor to the apparatus;
receiving refined beam indices predicted by a machine learning model, wherein the machine learning model is trained to predict beam indices from sensor information; and
establishing a refined BPL with the apparatus, based on the predicted the refined beam indices.
   46. The method of embodiment 45, further comprising:
providing user data; and
forwarding the user data to a host computer via the transmission to the base station.
   47. A method implemented in a communication system including a host computer, a base station and a user equipment (UE), the method comprising:

at the host computer, receiving user data transmitted to the base station from the UE, wherein the UE:
establishing an initial coarse Beam Pair Link (BPL) with an apparatus;
transmitting information from at least one sensor to the apparatus;
receiving refined beam indices predicted by a machine learning model, wherein the machine learning model is trained to predict beam indices from sensor information; and
establishing a refined BPL with the apparatus, based on the predicted the refined beam indices.
   48. The method of embodiment 47, further comprising:
at the UE, providing the user data to the base station.
   49. The method of embodiment 48, further comprising:
at the UE, executing a client application, thereby providing the user data to be transmitted; and
at the host computer, executing a host application associated with the client application.
   50. The method of embodiment 48, further comprising:
at the UE, executing a client application; and
at the UE, receiving input data to the client application, the input data being provided at the host computer by executing a host application associated with the client application,
wherein the user data to be transmitted is provided by the client application in response to the input data.
   51. A communication system including a host computer comprising a communication interface configured to receive user data originating from a transmission from a user equipment (UE) to a base station, wherein the base station comprises a radio interface and processing circuitry, the base station's processing circuitry configured to:
establish an initial coarse Beam Pair Link (BPL) with a device,
acquire information from at least one sensor at the device;
input the acquired information into a machine learning model, wherein the machine learning model is trained to predict beam indices from sensor information;
receive, from the machine learning model, refined beam indices, wherein the machine learning model has predicted the refined beam indices from the input information; and
establish a refined BPL with the device, based on the predicted refined beam indices.
   52. The communication system of embodiment 51, further including the base station.
   53. The communication system of embodiment 52, further including the UE, wherein the UE is configured to communicate with the base station.
   54. The communication system of embodiment 53, wherein:
the processing circuitry of the host computer is configured to execute a host application;
the UE is configured to execute a client application associated with the host application, thereby providing the user data to be received by the host computer.
   55. A method implemented in a communication system including a host computer, a base station and a user equipment (UE), the method comprising:

at the host computer, receiving, from the base station, user data originating from a transmission which the base station has received from the UE, wherein the UE:
establishing an initial coarse Beam Pair Link (BPL) with an apparatus;
transmitting information from at least one sensor to the apparatus;
receiving refined beam indices predicted by a machine learning model, wherein the machine learning model is trained to predict beam indices from sensor information; and
establishing a refined BPL with the apparatus, based on the predicted the refined beam indices.
   56. The method of embodiment 55, further comprising:
at the base station, receiving the user data from the UE.
   57. The method of embodiment 56, further comprising:
at the base station, initiating a transmission of the received user data to the host computer.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood. It will be further understood that terms used herein should be interpreted as having a meaning that is consistent with their meaning in the context of this specification and the relevant art and will not be interpreted in an idealized or overly formal sense unless expressly so defined herein.

Modifications and other variants of the described embodiments will come to mind to one skilled in the art having benefit of the teachings presented in the foregoing description and associated drawings. Therefore, it is to be understood that the embodiments are not limited to the specific example embodiments described in this disclosure and that modifications and other variants are intended to be included within the scope of this disclosure. Furthermore, although specific terms may be employed herein, they are used in a generic and descriptive sense only and not for purposes of limitation. Therefore, a person skilled in the art would recognize numerous variations to the described embodiments that would still fall within the scope of the appended claims. As used herein, the terms “comprise/comprises” or “include/includes” do not exclude the presence of other elements or steps. Furthermore, although individual features may be included in different claims, these may possibly advantageously be combined, and the inclusion of different claims does not imply that a combination of features is not feasible and/or advantageous. In addition, singular references do not exclude a plurality.

1. A method implemented by an apparatus for performing beam management, the method comprising:
establishing an initial coarse Beam Pair Link, BPL, with a device;
acquiring information from at least one sensor at the device;
inputting the acquired information into a machine learning model, the machine learning model being trained to predict beam indices from sensor information;
receiving, from the machine learning model, refined beam indices, wherein the machine learning model has predicted the refined beam indices from the input information; and
establishing a refined BPL with the device, based on the predicted refined beam indices.

2. The method according to claim 1, wherein the method further comprises:
processing the acquired sensor information; and
inputting the processed sensor information into the machine learning model.

3. The method according to claim 1, wherein the acquired sensor information includes location information indicative of a location of the device.

4. The method according to claim 1, wherein the method further comprises:
tracking accuracy of the predicted beam indices; and
updating the machine learning model in accordance with the tracked accuracy.

5. The method according to claim 4, wherein tracking accuracy of the predicted beam indices comprises:
comparing the predicted beam indices to a set of strongest Channel State Information Reference Symbol, CSI-RS, measurements received from the device.

6. The method according to claim 4, wherein tracking accuracy of the predicted beam indices comprises:
confirming whether messages between the apparatus and the device were received correctly using ACK/NACK information.

7. The method according to claim 1, wherein the method, when the machine learning model is in a training mode, further comprises:
obtaining a refined BPL by refining the initial coarse BPL by beam sweeping, wherein the obtained refined BPL is used as target data for the machine learning model; and
feeding the machine learning model with the obtained target data.

8. The method according to claim 1, wherein the machine learning model is located separately and remotely from the apparatus.

9. The method according to claim 8, wherein the machine learning model is located within a computer server system comprising one or more computer servers.

10. The method according to claim 1, wherein machine learning model is internal to the apparatus.

11. An apparatus, comprising:
a processing circuitry; and
a memory circuitry storing computer program code which, when run in the processing circuitry, causes the apparatus to perform beam management, wherein the computer program code, when run in the processing circuitry, causes the apparatus to:
establish an initial coarse Beam Pair Link, BPL, with a device;
acquire information from at least one sensor at the device;
input the acquired information into a machine learning model, wherein the machine learning model is trained to predict beam indices from sensor information;
receive, from the machine learning model, refined beam indices, the machine learning model having predicted the refined beam indices from the input information; and
establish a refined BPL with the device, based on the predicted refined beam indices.

12. The apparatus according to claim 11, wherein the memory circuitry storing computer program code which, when run in the processing circuitry, causes the apparatus to train the machine learning model by:
processing the acquired sensor information; and
inputting the processed sensor information into the machine learning model.

13. The apparatus according to claim 11, wherein the acquired sensor information includes location information indicative of a location of the device.

14. The apparatus according to claim 11, wherein the memory circuitry storing computer program code which, when run in the processing circuitry, causes the apparatus to:
track accuracy of the predicted beam indices; and
update the machine learning model in accordance with the tracked accuracy.

15. The apparatus according to claim 14, wherein the memory circuitry storing computer program code which, when run in the processing circuitry, causes the apparatus to track accuracy of the predicted beam indices by:
comparing the predicted beam indices to a set of strongest Channel State Information Reference Symbol, CSI-RS, measurements received from the device.

16. The apparatus according to claim 14, wherein the memory circuitry storing computer program code which, when run in the processing circuitry, causes the apparatus to track accuracy of the predicted beam indices by:
confirming whether messages between the apparatus and the device were received correctly using ACK/NACK information.

17.-22. (canceled).

23. A method implemented by a device, for performing beam management, the method comprising:
establishing an initial coarse Beam Pair Link, BPL, with an apparatus;
transmitting information from at least one sensor to the apparatus;
receiving refined beam indices predicted by a machine learning model, the machine learning model being trained to predict beam indices from sensor information; and
establishing a refined BPL with the apparatus, based on the predicted the refined beam indices.

24. The method according to claim 23, wherein the sensor information includes location information indicative of a location of the device.

25. The method according to claim 24, wherein the sensor information is comprised of at least one from a group consisting of GPS information, barometric pressure, temperature, accelerometer input and device orientation.

26. A device comprising:
a processing circuitry; and
a memory circuitry storing computer program code which, when run in the processing circuitry, causes the device to perform beam management, the computer program code, when run in the processing circuitry, causing the device to:
establish an initial coarse Beam Pair Link, BPL, with an apparatus;
transmit information from at least one sensor to the apparatus;
receive refined beam indices predicted by a machine learning model, the machine learning model being trained to predict beam indices from sensor information; and
establish a refined BPL with the apparatus, based on the predicted the refined beam indices.

27.-31. (canceled).
